(19) United States
(12) Patent Application Publication
(10) Pub. No.: US 2009/0255360 A1
(43) Pub. Date: Oct. 15, 2009

(54) HEEL SHIFTER FOR A MOTORCYCLE

(75) Inventors: Jack Brian Witteveen, Delta, AL (US); Thomas Edward Strunsee, Waukesha, WI (US); Brent Ahlers, Muskego, WI (US); Kristopher T. Lepkowski, Waukesha, WI (US); Jesse David Williams, Hershey, PA (US)

Correspondence Address: MICHAEL BEST & FRIEDRICH LLP, 100 E WISCONSIN AVENUE, Suite 3300, MILWAUKEE, WI, 53202, US

(73) Assignee: Harley-Davidson Motor Company Group, Inc., Milwaukee, WI (US)

(21) Appl. No.: 12/100,142

(22) Filed: Apr. 9, 2008

(51) Int. Cl. G05G 1/30

(52) U.S. Cl. 74/473.16

(57) ABSTRACT

A gear shifter for a motorcycle having a rotatable shifter shaft. The gear shifter includes a shifter arm having a first portion and a second portion. The first portion of the shifter arm is configured to engage the shifter shaft. The gear shifter further includes a shifter peg movably coupled to the second portion of the shifter arm such that the shifter peg is pivotable with respect to the shifter arm between a first position and a second position. A retainer assembly is operable to selectively retain the shifter peg in each of the first and the second positions.

### BACKGROUND

The present invention relates to motorcycles, and more particularly to motorcycles having heel activated shift mechanisms.

Due to their unique configuration, motorcycles have operating controls that are different than the controls of traditional four-wheeled automobiles. Although various control layouts have been utilized throughout motorcycling history, the industry has for many years agreed upon one configuration in particular. This configuration includes a right-hand throttle control, a left-hand clutch control, a right-foot rear brake control, and a left-foot gear selection control. While some motorcycles stray from this configuration, the vast majority of modern motorcycles utilize the above described control layout.

To operate the left-foot gear selector, a rider typically presses downwardly on a shifter peg with their toe to select a lower gear and lifts upwardly on the shifter peg with their toe to select a higher gear. Certain motorcycles, in particular those designed for long distance riding, utilize footboards instead of foot pegs to support a rider's feet. Footboards provide additional support and allow a rider greater flexibility with regard to foot positioning when compared to foot pegs. One disadvantage of footboards however is that in order for a rider to shift the bike into a higher gear by lifting upwardly on the shifter peg, the rider must maneuver their toe between the footboard and the shifter peg. This may be difficult to accomplish, especially when wearing boots or similar bulky footwear.

A widely accepted solution to this problem has been to provide an additional shift lever that is operated by the heel. The additional shift lever is coupled to the toe-activated shift lever in such a way that pressing downwardly on the additional shift lever with the heel shifts the motorcycle into a higher gear. This achieves the same result as lifting upwardly on the toe-activated shift lever. The addition of a heel-activated shift lever simplifies the gear selection process and improves the overall usability of the motorcycle.

### SUMMARY

The present invention resulted from the recognition that some riders do not want a heel shifter. For example, some riders do not use a heel shifter and would rather pull up on the toe shifter to upshift. Other riders use the heel shifter, but want it positioned out of the way when not being used, such as during highway riding.

In one embodiment, the invention provides a gear shifter for a motorcycle having a rotatable shifter shaft. The gear shifter includes a shifter arm having a first portion and a second portion. The first portion of the shifter arm is configured to engage the shifter shaft. The gear shifter further includes a shifter peg movably coupled to the second portion of the shifter arm such that the shifter peg is pivotable with respect to the shifter arm between a first position and a second position. A retainer assembly is operable to selectively retain the shifter peg in each of the first and the second positions.

In another embodiment the invention provides a gear shifter for a motorcycle having a rotatable shifter shaft. The gear shifter includes a shifter arm having a first portion, a second portion, and a central portion between the first and the second portions. The central portion of the shifter arm is configured to engage the shifter shaft. The gear shifter further includes a toe shifter peg coupled to the first portion of the shifter arm and a heel shifter peg coupled to the second portion of the shifter arm. The heel shifter peg is movably coupled to the shifter arm such that that the heel shifter peg is pivotable with respect to the shifter arm between a first position and a second position.

Other aspects of the invention will become apparent by consideration of the detailed description and accompanying drawings.

### BRIEF DESCRIPTION OF THE DRAWINGS

FIG. 1 is a side view of a motorcycle that includes a gear shifter embodying the present invention.

FIG. 2a is a perspective view of the gear shifter of FIG. 1 illustrating a heel shifter peg in an operating position.

FIG. 2b is a perspective view of the gear shifter shown in FIG. 2a with the heel shifter peg in a stowed position.

FIG. 3 is a rear perspective view of a rear shifter arm of the gear shifter of FIG. 2a with portions of the rear gear shifter exploded.

FIG. 4a is a cross-sectional view of the rear shifter arm taken along line 4a-4a of FIG. 3 illustrating a pivot of the gear shifter in the operating position.

FIG. 4b is a cross-sectional view similar to FIG. 4a but with the pivot in the stowed position.

FIG. 5 is a perspective view of a pivot of the gear shifter of FIG. 2a.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

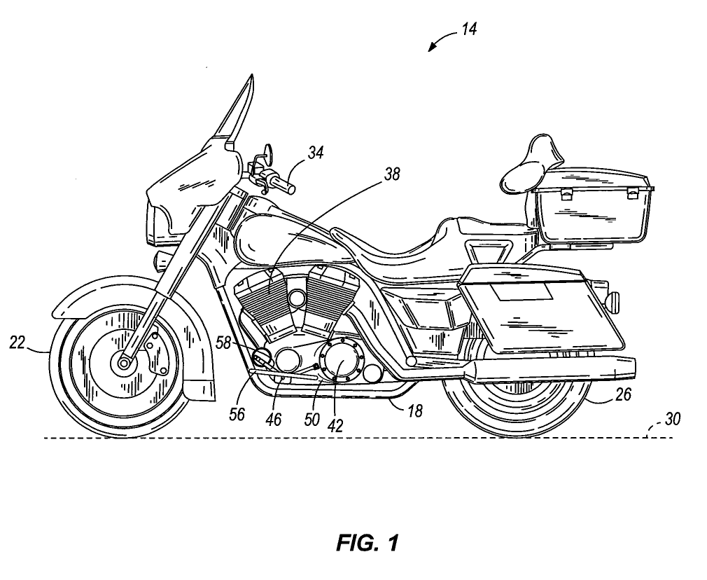

FIG. 1 illustrates a motorcycle 14 having a frame 18 and a front wheel 22 and a rear wheel 26 that support the frame 18 above a support surface 30. The front wheel 22 is coupled to the frame 18 such that the front wheel 22 can pivot about a steering axis using handlebars 34, as well known in the art.

The motorcycle 14 further includes an engine 38 coupled to the frame 18 between the front and rear wheels 22 and 26. A transmission 42 is coupled to the frame 18 and the transmission 42 is operable with the engine 38, as would be understood by those of ordinary skill in the art, to drive the rear wheel 26.

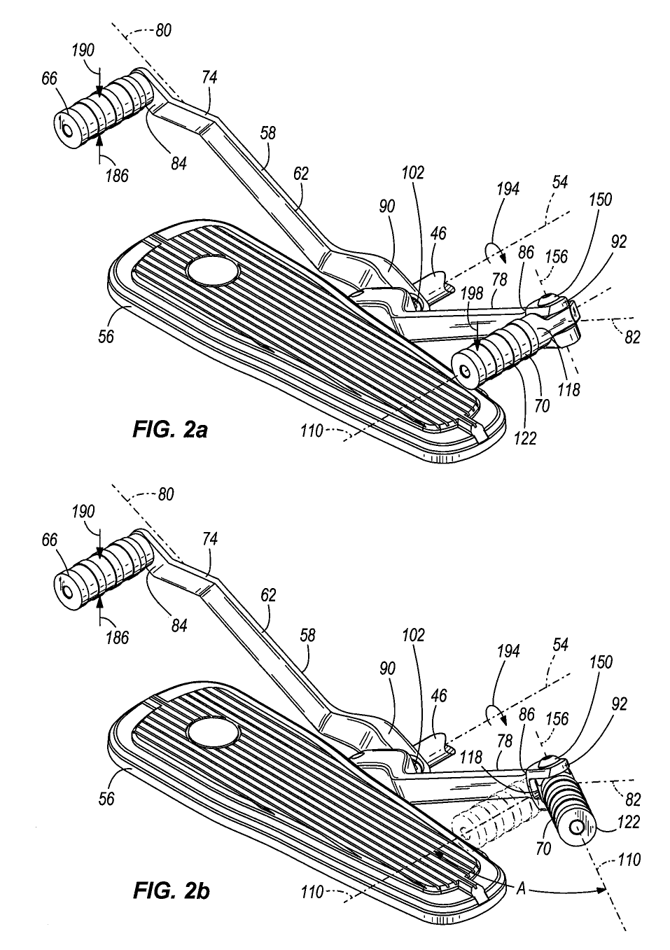

Referring to FIGS. 1 and 2a, the transmission 42 includes a shifter shaft 46 that extends outwardly past a primary cover 50 of the transmission 42. As would be understood by those skilled in the art, the shifter shaft 46 is rotatable or pivotable about a shift axis 54 (see FIG. 2a) to shift or change operating gears of the transmission 42. In the illustrated construction, a footboard 56 is coupled to the motorcycle 14 adjacent the shifter shaft 46. While the illustrated motorcycle includes the footboard 56, in other constructions the motorcycle can include foot pegs and the like.

With continued reference to FIG. 2a, a gear shifter 58 is coupled to the shifter shaft 46 to facilitate rotation of the shifter shaft 46 by a rider of the motorcycle 14. The gear shifter 58 includes a shifter lever or shift arm 62, a toe shifter peg 66, and a heel shifter peg 70. The illustrated shifter arm 62 is a two-piece shifter arm that includes a first or front shifter arm 74 and a second or rear shifter arm 78. The front shifter arm 74 includes a longitudinal axis 80 and the rear shifter arm 78 includes a longitudinal axis 82. In the illustrated construction, the longitudinal axes 80 and 82 of the front and rear shifter arms 74 and 78, respectively, intersect at the shifter shaft 46.

While the illustrated shifter arm 62 includes separate front and rear arms 74 and 78 that are each independently secured to the shifter shaft 46, in other constructions the shifter arm 62 can be a one-piece type shifter arm where the illustrated front and rear arms 74 and 78 are integrally formed as a single component.

The shifter arm 62 further includes a front portion 84, a rear portion 86, and a central portion 90 between the front and rear portions 84 and 86. A yoke 92 is formed at the rear portion 84 of the shifter arm 62, the purpose of which will be discussed in detail below.

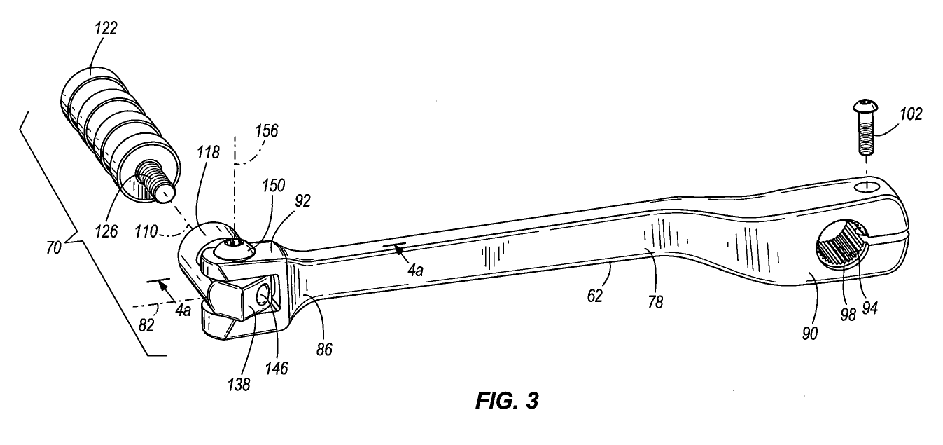

Referring to FIGS. 2a and 3, the central portion 90 includes an aperture 94 that extends through the shifter arm 62. An internal splined surface 98 is formed within the aperture 94, and a bolt 102 is received by the shifter arm 62 to expand or contract the aperture 94 as understood in the art. Also, as would be understood by one of skilled in the art, the shifter shaft 46 includes a corresponding splined surface formed near the end of the shifter shaft 46 that engages the splined surface 98 of the shifter arm 62 to couple the shifter arm 62 to the shifter shaft 46 for co-rotation. The bolt 102 is utilized to tighten the connection between the shifter arm 62 and the shifter shaft 46. While only the rear shift arm 78 is illustrated in FIG. 3, the front shifter arm 74 includes nearly the same configuration of the aperture 94, the splined surface 98, and the bolt 102 in order to couple the front shifter arm 74 to the shifter shaft 46.

With continued reference to FIG. 2a, the toe shifter peg 66 is coupled the front portion 84 of the shifter arm 62. In one construction, the toe shifter peg 66 is fixed to the front portion 84 of the shifter arm 62 using a threaded fastener, such as a bolt, and in other constructions other suitable fasteners and the like can be used to couple the toe shifter peg 66 to the shifter arm 62.

Referring to FIGS. 2a and 3, the gear shifter 58 further includes the heel shifter peg 70. The heel shifter peg 70 includes a longitudinal axis 110, and the heel shifter peg 70 is coupled to the rear portion 86 of the shifter arm 62. In the illustrated construction, the heel shifter peg 70 is coupled to the rear shifter arm 78. The illustrated heel shifter peg 70 includes a pivot 118 and a peg 122. As best seen in FIG. 3, the peg 122 is removably coupled to the pivot 118 using a threaded fastener 126 that extends from an end of the peg 122. In other constructions, the peg 122 can be coupled to the pivot 118 using any suitable device, and in yet other constructions, the pivot 118 and the peg 122 can be formed as one component.

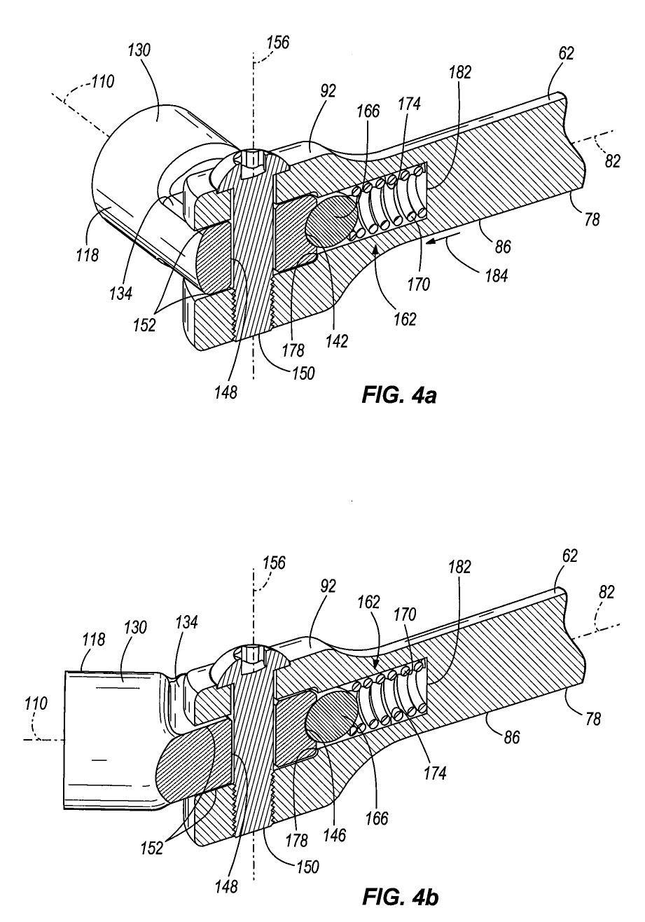

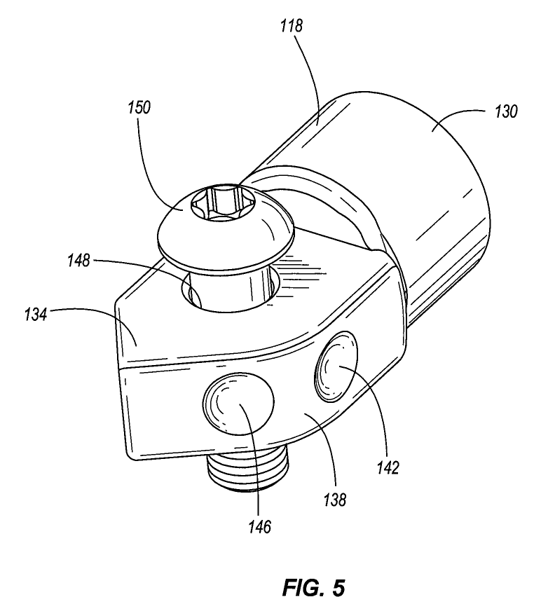

Referring to FIG. 5, the pivot 118 includes a cylindrical portion 130 and a coupling portion 134. The cylindrical portion 130 includes a threaded bore (not shown) that receives the fastener 126 of the peg 122 to couple the peg 122 and the pivot 118. The coupling portion 134 includes an arcuate outer surface 138. First and second recesses 142, 146 are formed in the arcuate outer surface 138, the purpose of which will be discussed further below. An aperture 148 extends through the coupling portion 134, and the aperture 148 receives a fastener, which is a bolt 150 in the illustrated construction, to couple the pivot 118 to the shifter arm 62 using the yoke 92, as illustrated in FIG. 4a. Alternatively, a pin, or any other suitable fastener, may be substituted for the bolt 150. As best seen in FIG. 4a, the bolt 150 couples the pivot 118 to the shifter arm 62 and gaps 152 are maintained on both sides of the coupling portion 134 between the pivot 118 and the yoke 92. Therefore, the pivot 118 and the heel shifter peg 70 (FIG. 2a) can pivot or rotate with respect to the shifter arm 62 about an axis 156.

With continued reference to FIG. 4a, the gear shifter 58 further includes a retainer assembly 162. The retainer assembly 162 includes a detent member and a biasing member biasing the detent member toward the heel shifter peg 70. In the illustrated construction, the detent member is a ball 166, which is formed from DELRIN in one construction, and the biasing member is a coil spring 170. However, in other constructions, the biasing member can be virtually any suitable biasing member. The spring 170 and ball 166 are located within a bore 174 formed in the shifter arm 62. The bore 174 includes an open end 178 and a closed end 182. The open end 178 opens toward the yoke 92 of the shifter arm 62. The spring 170 acts against the closed end 182 of the bore 174 to bias the ball 166 in the direction of arrow 184 of FIG. 4a and into contact with the pivot 118.

Referring to FIGS. 1 and 2a, in operation, the rider of the motorcycle 14 can utilize the toe shifter peg 66 to shift the transmission 42 by either lifting upwardly, generally in the direction of arrow 186 of FIG. 2a, with their toe or by pressing downwardly, generally in the direction of arrow 190 of FIG. 2a. Such operation of the toe shifter peg 66 would be understood by one of skill in the art.

If the rider lifts upwardly on the toe shifter peg 66 with their toe, the shifter shaft 46 rotates in the clockwise direction illustrated in FIG. 2a or in the direction of arrow 194. Rather than lifting upwardly on the toe shifter peg 66 to rotate the shifter shaft 46 in the direction 194, the rider can press downwardly, generally in the direction of arrow 198, on the heel shifter peg 70 using the rider's heel.

FIG. 2a illustrates the heel shifter peg 70 in a first or operating position. In the illustrated operating position, the longitudinal axis 110 of the heel shifter peg 70 is about normal or about 90 degrees to the longitudinal axis 82 of the rear shifter arm 78. Of course, in other operating positions, the longitudinal axis 110 of the heel shifter peg 70 can be at other suitable angles with respect to the longitudinal axis 82 of the rear shifter arm 78.

In the operating position, the heel shifter peg 70 is in a convenient position for the rider to use their heel to press down on the heel shifter peg 70 and shift the motorcycle 14. However, the rider may desire to move the heel shifter peg 70 to a stowed position as illustrated in FIG. 2b. Typically, during operation of the motorcycle 14, the rider rest their foot on the footboard 56, and when the heel shifter peg 70 is in the operating position (FIG. 2a), the heel shifter peg 70 can restrict the location on the footboard 56 where the rider can rest their foot. Therefore, especially during long rides, the rider may desire to move the heel shifter peg 70 to the stowed position of FIG. 2b. As illustrated in FIG. 2b, in the stowed position the longitudinal axis 110 of the heel shifter peg 70 is at an greater than 90 degrees to the longitudinal axis 82 of the rear shifter arm 78, thereby providing more maneuverability for the rider's foot on the footboard 56.

To move the heel shifter peg 70 to the stowed position, the rider rotates or pivots the heel shifter peg 70 about the pivot axis 156 from the position illustrated in FIG. 2a to the position illustrated in FIG. 2b. Referring to FIGS. 4a and 5, in the operating position, the ball 166 of the retainer assembly 162 is received in the first recess 142 of the pivot 118. The ball 166 is biased into contact with the first recess 142 and the pivot 118 by the spring 170 to selectively retain the heel shifter peg 70 in the operating position. However, if the user applies a sufficient force to the heel shifter peg 70 to pivot the peg 70 about the axis 156, the bias of the spring 170 is overcome and the ball 166 rolls out of the first recess 142 and along the arcuate outer surface 138 of the pivot 118. The user rotates the heel shifter peg 70 to the second or stowed position where the ball 166 is received in the second recess 146. With the ball 166 in the second recess 146, the spring 170 biases the ball 146 into contact with the second recess 146 of the pivot 118 to selectively retain the heel shifter peg 70 in the stowed position. If the rider desires to place the heel shifter peg 70 back in the operating position, the heel shifter peg 70 can be rotated about the axis 156 back to the operating position.

The first and second recesses 142, 146 are spaced on the arcuate outer surface 138 to provide an acute included angle A between the orientation of the axis 110 when the heel shifter peg 70 is in the operating position (shown in phantom in FIG. 2a) and the orientation of the axis 110 when the heel shifter peg 70 is in the stowed position (shown in solid FIG. 2b). In the illustrated construction, the acute included angle A is about 45 degrees. In alternative constructions, however, the first and second recesses 142, 146 may be spaced accordingly so that the acute included angle A is more or less than about 45 degrees.

While in the illustrated construction, the retainer assembly 162 that selectively retains the heel shifter peg 70 in the stowed and operating positions includes the ball 166 and the spring 170, it should be understood that the retainer assembly can include other components or can utilize other portions of the shifter 58. For example, in one construction, the heel shifter peg can be biased by a spring, such as a torsion spring toward the operating position and the heel shifter can contact the shifter arm 62 to retain the heel shifter peg in the operating position. In such a construction, a ball, spring and recess, as described above can be utilized to retain the heel shifter peg in the stowed position.

Also, while the illustrated heel shifter peg 70 rotates about the pivot axis 156, which is about normal to the longitudinal axis 82 of the rear shifter arm 78 and somewhat vertically oriented, in other constructions, the pivot axis of the heel shifter peg 70 can have other suitable orientations with respect to the rear shifter arm. For example, in one construction, the pivot axis of the heel shifter can be horizontally orientated (i.e., generally in the orientation of the illustrated shift axis 54).

Various features and advantages of the invention are set forth in the following claims.

What is claimed is:

1. A gear shifter for a motorcycle, the motorcycle having a rotatable shifter shaft, the gear shifter comprising:
a shifter arm having a first portion and a second portion, the first portion configured to engage the shifter shaft;
a shifter peg movably coupled to the second portion of the shifter arm such that the shifter peg is pivotable with respect to the shifter arm between a first position and a second position; and
a retainer assembly operable to selectively retain the shifter peg in each of the first and the second positions.

2. The gear shifter of claim 1, wherein the shifter peg is a heel shifter peg.

3. The gear shifter of claim 1, wherein the first position is an operating position of the shifter peg, and wherein the second position is a stowed position of the shifter peg.

4. The gear shifter of claim 1, wherein the shifter arm includes a longitudinal axis, wherein the shifter peg includes a longitudinal axis, wherein the longitudinal axis of the shifter peg is substantially normal to the longitudinal axis of the shifter arm when the shifter peg is in the first position.

5. The gear shifter of claim 4, wherein the longitudinal axis of the shifter peg is at an angle greater than 90 degrees to the longitudinal axis of the shifter arm when the shifter peg is in the second position.

6. The gear shifter of claim 1, wherein the shifter arm includes a bore, wherein the retainer assembly includes a biasing member within the bore of the shifter arm and a detent member, wherein the biasing member biases the detent member into contact with the shifter peg to selectively retain the shifter peg in the first and the second positions.

7. The gear shifter of claim 6, wherein the shifter peg includes a first recess and a second recess, wherein the detent member is received in the first recess to retain the shifter peg in the first position, and wherein the detent member is received in the second recess to retain the shifter peg in the second position.

8. A gear shifter for a motorcycle having a rotatable shifter shaft, the gear shifter comprising:
a shifter arm having a first portion, a second portion, and a central portion between the first and the second portions, the central portion configured to engage the shifter shaft;
a toe shifter peg coupled to the first portion of the shifter arm; and
a heel shifter peg coupled to the second portion of the shifter arm,
wherein the heel shifter peg is movably coupled to the shifter arm such that that the heel shifter peg is pivotable with respect to the shifter arm between a first position and a second position.

9. The gear shifter of claim 8, wherein the first position is an operating position of the heel shifter peg, and wherein the second position is a stowed position of the heel shifter peg.

10. The gear shifter of claim 8, further comprising a retainer assembly configured to selectively retain the heel shifter peg in each of the first and the second positions.

11. The gear shifter of claim 10, wherein the shifter arm includes a bore, wherein the retainer assembly includes a biasing member within the bore of the shifter arm and a detent member, wherein the biasing member biases the detent member into contact with the heel shifter peg to selectively retain the heel shifter peg in the second position.

12. The gear shifter of claim 11, wherein the heel shifter peg includes a first recess and a second recess, wherein the detent member is received in the first recess to retain the heel shifter peg in the first position, and wherein the detent member is received in the second recess to retain the heel shifter peg in the second position.

13. The gear shifter of claim 8, wherein the shifter arm includes a first arm having the first portion and a second arm having the second portion, wherein the first arm and the second arm are independently securable to the motorcycle.

14. A motorcycle comprising:
a frame;
a front wheel pivotably coupled the frame to steer the motorcycle;
a rear wheel;
an engine coupled to the frame;
a transmission having a shifter shaft, the shifter shaft rotatable about a shift axis;
a shifter arm having a front portion, a rear portion, and a central portion between the front and the rear portions, the central portion coupled to the shifter shaft;
a toe shifter peg coupled to the front portion of the shifter arm; and
a heel shifter peg coupled to the rear portion of the shifter arm,
wherein the heel shifter peg is movably coupled to the shifter arm such that that the heel shifter peg is pivotable with respect to the shifter arm between a first position and a second position.

15. The motorcycle of claim 14, wherein the first position is an operating position of the heel shifter peg, and wherein the second position is a stowed position of the heel shifter peg.

16. The motorcycle of claim 14, further comprising a retainer assembly configured to selectively retain the heel shifter peg in each of the first and the second positions.

17. The motorcycle of claim 16, wherein the shifter arm includes a bore, wherein the retainer assembly includes a biasing member within the bore of the shifter arm and a detent member, wherein the biasing member biases the detent member into contact with the heel shifter peg to selectively retain the heel shifter peg in the second position.

18. The motorcycle of claim 14, wherein the shifter arm includes a longitudinal axis, wherein the heel shifter peg includes a longitudinal axis, wherein the longitudinal axis of the heel shifter peg is substantially normal to the longitudinal axis of the shifter arm when the heel shifter peg is in the first position.

19. The motorcycle of claim 18, wherein the longitudinal axis of the heel shifter peg is at an angle greater than 90 degrees to the longitudinal axis of the shifter arm when the heel shifter peg is in the second position.
